(19) United States
(12) Patent Application Publication
(10) Pub. No.: US 2026/0004558 A1
(43) Pub. Date: Jan. 1, 2026

(54) TRAINING APPARATUS, METHOD, AND IMAGE PROCESSING APPARATUS

(71) Applicant: KABUSHIKI KAISHA TOSHIBA, Tokyo (JP)

(72) Inventors: Gaku Minamoto, Kawasaki Kanagawa (JP); Satoshi Ito, Kawasaki Kanagawa (JP); Osamu Yamaguchi, Yokohama Kanagawa (JP); Reiko Noda, Kawasaki Kanagawa (JP)

(73) Assignee: KABUSHIKI KAISHA TOSHIBA, Tokyo (JP)

(21) Appl. No.: 19/248,844

(22) Filed: Jun. 25, 2025

(30) Foreign Application Priority Data
Jul. 1, 2024 (JP) 2024-106111

(51) Int. Cl. G06V 10/74; G06T 7/00; G06V 10/77; G06V 10/774; G06V 10/82

(52) U.S. Cl. CPC G06V 10/761; G06T 7/0002; G06V 10/7715; G06V 10/774; G06V 10/82; G06T 2207/20081; G06T 2207/20084; G06T 2207/30184

(57) ABSTRACT

According to one embodiment, a training apparatus includes processing circuitry. The processing circuitry calculates a similarity between a subject image and at least one normal image. The processing circuitry selects at least one reference image from the normal image based on the similarity. The processing circuitry calculates first feature maps of the subject image and second feature maps of the reference image using a first machine learning model. The processing circuitry calculates differential feature maps that are differences between the first and second feature maps. The processing circuitry calculates a likelihood map based on the first feature maps and the differential feature maps using a second machine learning model. The processing circuitry calculates, based on the likelihood map and a teaching label of the subject image, a loss based on a likelihood. The processing circuitry updates the first and second machine learning models based on the loss.

### CROSS-REFERENCE TO RELATED APPLICATIONS

This application is based upon and claims the benefit of priority from Japanese Patent Application No. 2024-106111, filed Jul. 1, 2024, the entire contents of which are incorporated herein by reference.

### FIELD

Embodiments described herein relate generally to a training apparatus, a method, and an image processing apparatus.

### BACKGROUND

Inspection of infrastructures such as roads and power apparatuses has been increasingly automated. There has been developed a technique of detecting an anomaly of an inspection target (including damage and an anomaly state and also called a defect) from an image. For example, there is a road surface anomaly detection technique of detecting an anomaly of a road surface from a camera image. When training a machine learning model for estimating an anomaly position on a road surface by supervised learning, for example, a training data set that combines an image of a road and a circumscribed rectangle indicating an anomaly position in a subject image as a teaching label may be prepared, and training may be performed. However, when preparing the circumscribed rectangle indicating the anomaly position as a teaching label, the data labeling work takes time. In addition, when determining an anomaly portion, there is an individual difference depending on the data labeling worker.

Hence, there is a method in which a machine learning model is trained using weakly supervised learning that teaches only the presence/absence of an anomaly in an image, and the anomaly position in the image is detected using the trained model. As one of methods of improving image anomaly detection using supervised learning, there is a method of improving anomaly detection accuracy using the differential representation between a normal image and a subject image.

However, in the above-described method, the estimation accuracy of an anomaly position on an image including a detected anomaly is low. In addition, since a randomly sampled normal image is used, the detection performance lowers in inspection of an infrastructure facility due to the influence of variations in background or image capturing angle of view.

### BRIEF DESCRIPTION OF THE DRAWINGS

FIG. 1 is a block diagram showing an example of the configuration of an image inspection system according to the embodiment.

FIG. 2 is a block diagram showing an example of the configuration of a training apparatus according to the first embodiment.

FIG. 3 is a flowchart showing an example of the operation of the training apparatus according to the first embodiment.

FIG. 4 is a view showing an example of a subject image included in a training data set.

FIG. 5 is a conceptual view for explaining Multiple Instance learning for an image.

FIG. 6 is a view showing an example of a training method of a first machine learning model and a second machine learning model.

FIG. 7 is a block diagram showing an example of the configuration of an image processing apparatus according to the second embodiment.

FIG. 8 is a flowchart showing an example of the operation of the image processing apparatus according to the second embodiment.

FIG. 9 is a view showing an example of the display screen of the image processing apparatus according to the second embodiment.

FIG. 10 is a view showing an example of application to an application concerning a detection result of the image processing apparatus.

FIG. 11 is a block diagram showing an example of the hardware configuration of an information processing apparatus.

### DETAILED DESCRIPTION

In general, according to one embodiment, a training apparatus includes processing circuitry. The processing circuitry is configured to acquire a subject image and at least one normal image. The processing circuitry is configured to calculate a similarity between the subject image and the at least one normal image. The processing circuitry is configured to select at least one reference image from the at least one normal image based on the similarity. The processing circuitry is configured to calculate first feature maps of the subject image and second feature maps of the reference image using a first machine learning model. The processing circuitry is configured to calculate differential feature maps that are differences between the first feature maps and the second feature maps. The processing circuitry is configured to calculate a likelihood map based on the first feature maps and the differential feature maps using a second machine learning model. The processing circuitry is configured to calculate, based on the likelihood map and a teaching label of the subject image, a loss based on a likelihood. The processing circuitry is configured to update the first machine learning model and the second machine learning model based on the loss.

A training apparatus, a method, a program (non-transitory computer readable medium), and an image processing apparatus according to the embodiment will now be described in detail with reference to the accompanying drawings.

Note that in the following embodiments, parts denoted by the same reference numerals perform the same operations, and a repetitive description thereof will appropriately be omitted.

### First Embodiment

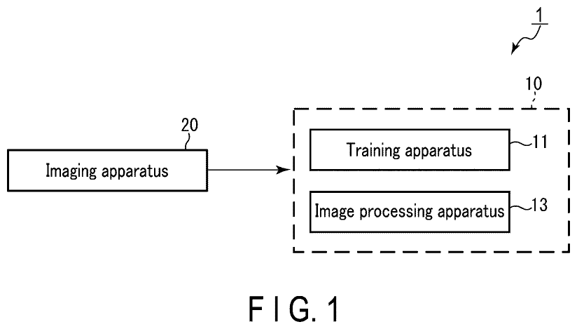

An example of the configuration of an image inspection system 1 according to the first embodiment will be described with reference to the block diagram of FIG. 1.

The image inspection system 1 shown in FIG. 1 is used to capture an image and inspect the presence/absence of an anomaly of an inspection target using the captured image. Here, the anomaly is an anomaly appearing in the inspection target. For example, an anomaly of a road surface is a crack, a rut, a pothole, a sinkhole, a recess, a step, or the like that occurs on the road surface. For an anomaly, a degree of severity according to the size, the depth, or the like of the anomaly may be defined. For example, concerning a pothole, the degree of severity may be defined as level “AA” or “A” in accordance with the size or depth.

The image inspection system 1 according to the first embodiment includes an information processing apparatus 10 and an imaging apparatus 20. The information processing apparatus 10 includes a training apparatus 11 and an image processing apparatus 13.

The training apparatus 11 executes training of a machine learning model using a training data set. The image processing apparatus 13 performs image processing for the captured image using the machine learning model trained by the training apparatus 11. The image processing apparatus 13 executes image processing for inspecting the presence/absence of an anomaly for the image captured by the imaging apparatus 20. Note that the image processing apparatus 13 may acquire the image directly from the imaging apparatus 20 or may be acquire the image from an external apparatus or external medium such as a server or a medium in which the image captured by the imaging apparatus 20 is saved. Note that in FIG. 1, one information processing apparatus 10 including the training apparatus 11 and the image processing apparatus 13 has been described, but the training apparatus 11 and the image processing apparatus 13 may be independent apparatuses.

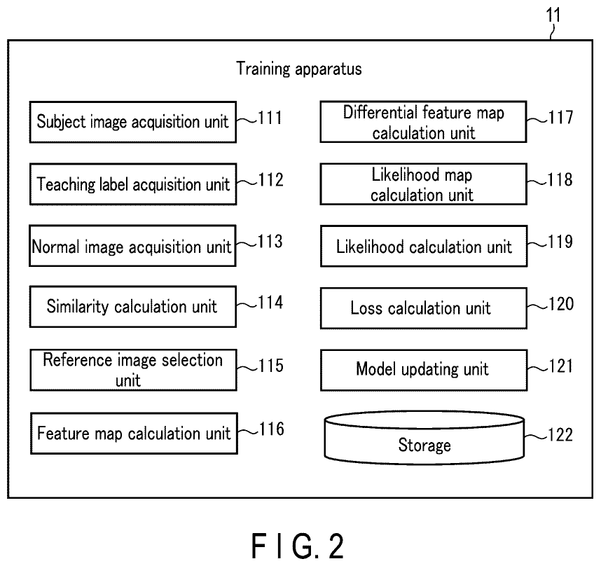

The functional configuration of the training apparatus 11 will be described next with reference to the block diagram of FIG. 2.

The training apparatus 11 includes a subject image acquisition unit 111, a teaching label acquisition unit 112, a normal image acquisition unit 113, a similarity calculation unit 114, a reference image selection unit 115, a feature map calculation unit 116, a differential feature map calculation unit 117, a likelihood map calculation unit 118, a likelihood calculation unit 119, a loss calculation unit 120, a model updating unit 121, and a storage 122.

The subject image acquisition unit 111 acquires a subject image that is a processing target included in a training data set. The subject image is, for example, an image obtained by capturing an inspection target and is an image including an anomaly or an image without including an anomaly.

The teaching label acquisition unit 112 acquires a teaching label indicating whether the subject image included in the training data set has an anomaly.

The normal image acquisition unit 113 acquires at least one normal image. The normal image is an image obtained by capturing an inspection target that includes no anomaly.

Using the subject image and the normal image, the similarity calculation unit 114 calculates the similarity of the normal image to the subject image.

The reference image selection unit 115 selects a reference image from normal images based on the similarity calculated by the similarity calculation unit 114.

The feature map calculation unit 116 acquires feature maps for each of the subject image and the reference image using a first machine learning model. That is, the feature map calculation unit 116 calculates first feature maps that are the feature maps of the subject image and second feature maps that are the feature maps of the reference image using the first machine learning model.

The differential feature map calculation unit 117 calculates differential feature maps that are the differences between the first feature maps and the second feature maps calculated by the feature map calculation unit 116.

The likelihood map calculation unit 118 calculates a likelihood map based on the first feature maps and the differential feature maps using a second machine learning model. The likelihood map is a score map indicating an anomaly likelihood at each position in an image.

The likelihood calculation unit 119 calculates the likelihood of the subject image from the likelihood map. The likelihood is a score indicating the likelihood of existence of an anomaly in the subject image (inclusion of an anomaly in the subject image).

The loss calculation unit 120 calculates a loss value based on the likelihood and the teaching label.

The model updating unit 121 optimizes the parameters (a weight coefficient, a bias, and the like) of each of the first machine learning model and the second machine learning model such that the loss value calculated by the loss calculation unit 120 is minimized.

The storage 122 stores the subject image, the normal image, the first machine learning model, the second machine learning model, and the like.

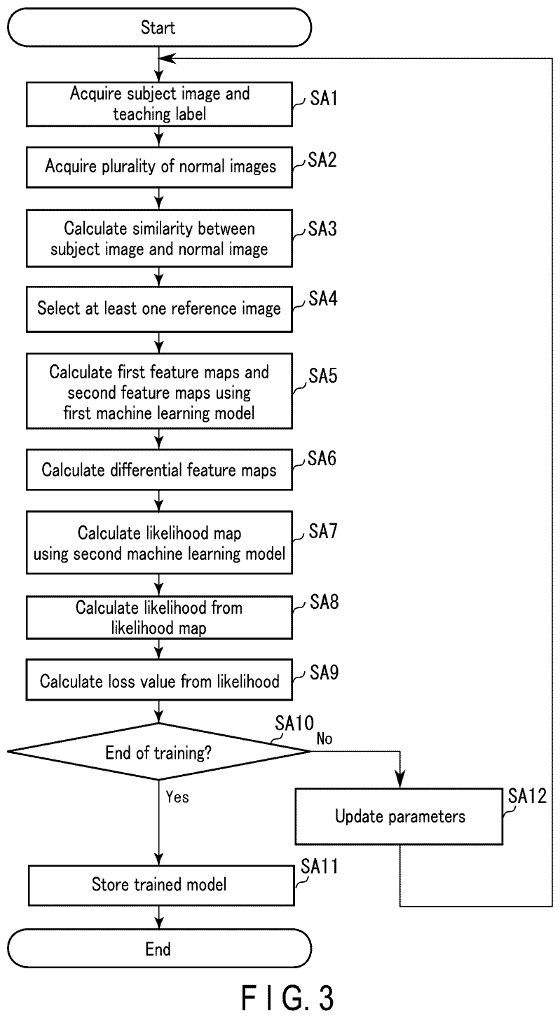

An example of the operation of the training apparatus 11 according to the first embodiment will be described next with reference to the flowchart of FIG. 3. The procedure of training executed by the training apparatus 11 according to the first embodiment is weakly supervised learning that combines only an image and the presence/absence of an anomaly included in the image as a teaching label and estimates an anomaly position in the image.

In step SA1, the subject image acquisition unit 111 acquires a subject image as training data, and the teaching label acquisition unit 112 acquires a teaching label corresponding to the subject image. The teaching label is a label indicating whether an anomaly portion is included in the subject image.

In step SA2, the normal image acquisition unit 113 acquires a plurality of normal images.

In step SA3, the similarity calculation unit 114 calculates the similarity between the subject image and the normal image. More specifically, the similarity calculation unit 114 may calculate the similarity using a model constructed by machine learning. The similarity calculation unit 114 may extract the representations of the subject image and the normal image using a neural network trained by supervised learning and calculate the similarity based on the extracted representations. For example, a Euclidean distance is calculated using the extracted representations and acquired as the similarity. Note that the similarity calculation unit 114 may receive a plurality of normal images and calculate the similarities of the plurality of normal images. For example, for all images in a training data set prepared for training of the training apparatus 11, the similarity calculation unit 114 may calculate similarities to all normal images in the training data set. Also, in another example, the similarity calculation unit 114 may calculate the similarity using metadata such as an image capturing date/time, an image capturing location, and weather held by an image. For example, if images have the same image capturing locations and the same image capturing date/time, the similarity is set high.

In step SA4, the reference image selection unit 115 selects at least one reference image. More specifically, the reference image selection unit 115 selects a normal image as the reference image based on the similarity calculated in step SA3. Also, the reference image selection unit 115 may acquire a plurality of normal images as reference images. In one example, the reference image selection unit 115 may probabilistically select an image to be acquired as a reference image from normal images based on similarities. For example, the reference image selection unit 115 may select a reference image at random from normal images each having a similarity equal to or more than a threshold. Alternatively, the higher the similarity of a normal image is, the higher the selection probability may be. Also, the reference image selection unit 115 may acquire N (N is a natural number of 1 or more) top normal images having higher similarities as reference images.

If the reference image is probabilistically selected, training can be performed such that the generalization performance of the first machine learning model and the second machine learning model is improved.

Note that in steps SA2 to SA4, an example in which at least one reference image is selected from a plurality of normal images has been described. For example, if one normal image is acquired, the normal image may be selected as the reference image.

In step SA5, the feature map calculation unit 116 calculates first feature maps concerning the subject image and second feature maps for the reference image using the first machine learning model. The first machine learning model is, for example, a convolutional neural network. The feature map calculation unit 116 has the role of an encoder that converts an image into a feature space of a lower dimension using the first machine learning model. In one example, the feature map calculation unit 116 may calculate feature maps obtained from the intermediate layers of the first machine learning model. More specifically, if ResNet is used as the first machine learning model, feature maps obtained from each intermediate layer is calculated. Since the output size of feature maps changes depending on the intermediate layer, a plurality of feature maps having different output sizes can be calculated.

In step SA6, the differential feature map calculation unit 117 calculates the differences between the first feature maps and the second feature maps as differential feature maps. For example, using the intermediate layers calculated by the feature map calculation unit 116, the differential feature map calculation unit 117 may calculate differential feature maps having different output sizes from the intermediate layers. Also, if the feature map calculation unit 116 receives a plurality of reference images and calculates the feature maps of each reference image, the differential feature map calculation unit 117 may calculate the differences between the first feature maps and the average of the feature maps of the plurality of reference images as the differential feature maps. Also, the differential feature map calculation unit 117 may calculate the differential feature maps using the weighted average of the feature maps of the plurality of reference images based on the similarities. More specifically, the differential feature map calculation unit 117 may weighted-average the plurality of reference images such that a large weight is added to the reference image having a high similarity, and calculate the difference between the average and the first feature maps as the differential feature maps.

In step SA7, the likelihood map calculation unit 118 calculates a likelihood map based on the first feature maps and the differential feature maps using the second machine learning model. The second machine learning model is, for example, a convolutional neural network that performs up-sampling processing. The lengths of the likelihood map in the longitudinal direction and the lateral direction are assumed to be the same as those of the subject image. The likelihood map, for example, takes a continuous value from 0 to 1 as scores for each region corresponding to each pixel of the subject image. If the value is large, it indicates a likelihood of being a specific anomaly. According to the likelihood map, it is possible to visualize which position in the subject image may have an anomaly.

In step SA8, the likelihood calculation unit 119 calculates a likelihood concerning the presence/absence of an anomaly in the subject image using the likelihood map. The likelihood is, for example, a continuous value from 0 to 1, and if the value is large, it indicates that the image includes an anomaly. For example, the likelihood calculation unit 119 calculates the maximum value in the likelihood map as the likelihood.

In step SA9, the loss calculation unit 120 calculates a loss value using a loss function based on the likelihood. As the loss function, for example, BinaryCrossEntropyLoss is used. Letting p be the score for the image, and y be the label for the image, a loss value (L) is calculated by

$$L = - y log p - ( 1 - y ) log ( 1 - p ) \qquad ( 1 )$$

In step SA10, the model updating unit 121 determines whether training of the first machine learning model and the second machine learning model is ended. More specifically, for example, the model updating unit 121 determines whether the loss value (L) calculated in step SA9 is equal to or smaller than a threshold. If the loss value (L) is equal to or smaller than the threshold, it is considered that the loss value (L) converges. Hence, it is determined that training of the first machine learning model and the second machine learning model is ended. On the other hand, if the loss value (L) is larger than the threshold, it is determined that training of the first machine learning model and the second machine learning model is not ended. Note that whether training is ended can be determined using not the above-described determination method but a general determination method of a machine learning model.

If training of the first machine learning model and the second machine learning model is ended, the process advances to step SA11. If training of the first machine learning model and the second machine learning model is not ended, the process advances to step SA12.

In step SA11, the storage 122 stores a first trained model that is the trained first machine learning model and a second trained model that is the trained second machine learning model. Note that the first trained model and the second trained model will also be referred to as a trained model altogether hereinafter.

In step SA12, the model updating unit 121 updates the parameters of the first machine learning model and the second machine learning model. The process returns to step SA1, and the processing is repeated until the training is ended. That is, the parameters of the first machine learning model and the second machine learning model are updated such that the loss value (L) is minimized.

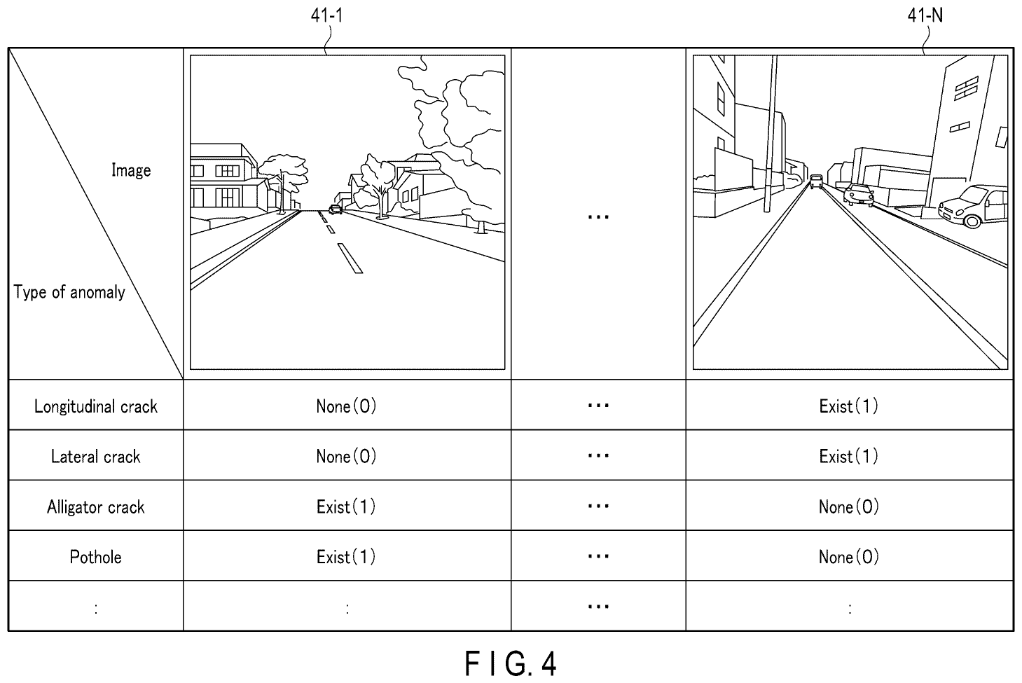

An example of the subject image included in the training data set will be described next with reference to FIG. 4.

As shown in FIG. 4, as an example of a subject image 41, a captured image of the surface of a road is assumed. As a teaching label corresponding to the subject image 41, whether an anomaly exists on the road surface is shown for each anomaly type.

In the example shown in FIG. 4, “longitudinal crack, lateral crack, alligator crack, and pothole” are shown as anomaly types, and presence/absence for each anomaly type is associated as a teaching label. More specifically, for a subject image 41-1, a teaching label indicating that “longitudinal crack and lateral crack” are not included, but “alligator crack and pothole” exist is added. For example, the teaching label corresponding to the subject image 41-1 may be expressed as [0, 0, 1, 1] using vector notation. For a subject image 41-N, since “longitudinal crack and lateral crack” exist, but “alligator crack and pothole” do not exist, the teaching label may be expressed as [1, 1, 0, 0] using vector notation.

At this time, the teaching label does not indicate at which point of the subject image 41 an anomaly exists. Training is performed using only the above-described image and the presence/absence of an anomaly in the image as the teaching label, and the framework of Multiple instance learning can be applied to problem setting for estimating an anomaly position in the image.

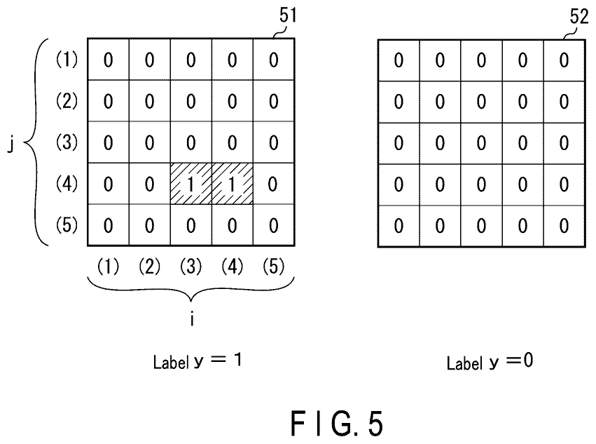

Multiple instance learning for an image will be described next with reference to the conceptual view of FIG. 5.

Multiple instance learning is one of supervised learning methods. In general supervised learning, the label y is added to each sample x. On the other hand, in Multiple instance learning, a correct answer label is added to a set formed by putting a plurality of instances together. In Multiple instance learning, the set is called a bag. For example, a correct answer label in a case of a 2-class identification task will be described. The label y=0 is added as a negative example to a bag in which all instances are negative examples, and the label y=1 is added as a positive example to a bag including at least one instance of the positive example. The purposes of Multiple instance learning are to train a machine learning model for estimating the label of a bag and train a machine learning model for estimating the label of each instance in a bag.

In the example shown in FIG. 5, a case where only one anomaly type is to be detected will be examined. If anomaly detection for a road image is interpreted as Multiple instance learning, each region (i, j) in an image 51 corresponds to an instance. Here, i is an index indicating the lateral-direction position in the image, and j is an index indicating the longitudinal-direction position in the image. For example, each region (i, j) may be a pixel or may be a patch formed by dividing the image. Also, the image corresponds to a bag formed by putting instances together.

The image 51 is an image in a case where an anomaly exists, and indicates that anomalies exist in regions (i, j)=(3, 4) and (4, 4). On the other hand, an image 52 is an image including no anomaly. Each of the images 51 and 52 shows the relationship between a label tᵢⱼ for each region (i, j) and the label y for the image. Here, “1” indicates existence of an anomaly, and “0” indicates absence of an anomaly. The label y=1 indicating existence of an anomaly is added to the image 51 including at least one region with an anomaly, and the label y=0 indicating absence of an anomaly is added to the image 52 whose all regions include no anomaly.

Here, a relationship representing that the maximum value of the label tᵢⱼ for a region equals the label y for the image, as indicated by equation (2).

$$y = {max}_{i , j} {t}_{i j} \qquad ( 2 )$$

As described above, in the training method of the first machine learning model and the second machine learning model, considering the image as a bag and each region in the image as an instance, the framework of Multiple instance learning using only the image and the presence/absence of an anomaly in the image as the teaching label can be applied.

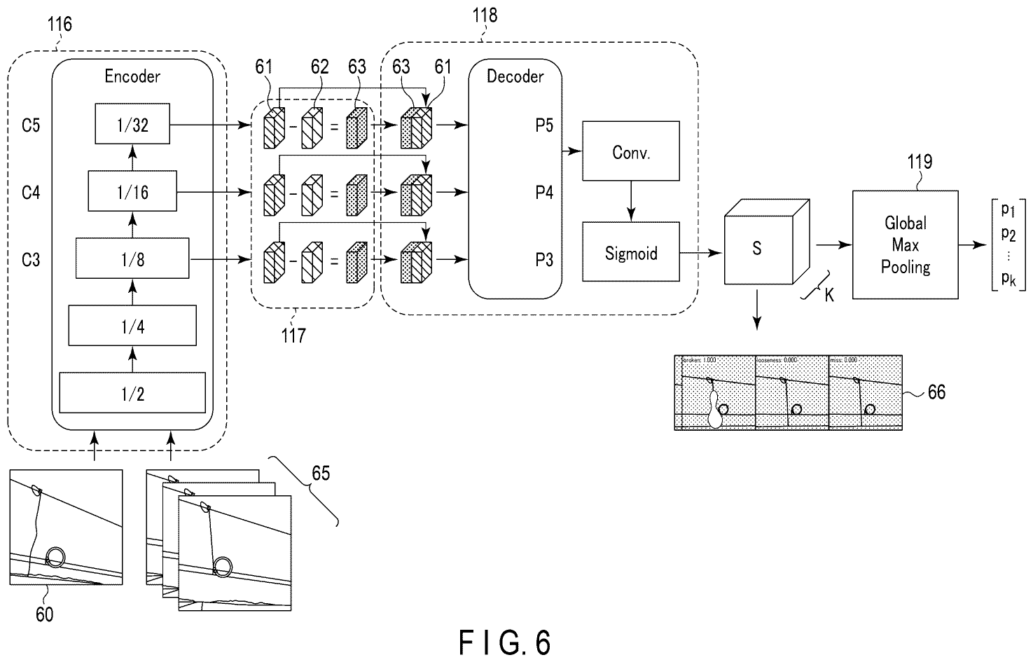

An example of the training method of the first machine learning model and the second machine learning model will be described next with reference to FIG. 6.

FIG. 6 shows processing for the subject image in the feature map calculation unit 116, the differential feature map calculation unit 117, the likelihood map calculation unit 118, and the likelihood calculation unit 119.

The first machine learning model and the second machine learning model are formed by a Fully Convolutional Network formed by a convolutional operation having locality in the spatial direction. In the first embodiment, it is assumed that a structure of a Feature Pyramid Network in which the first machine learning model is an encoder and the second machine learning model is a decoder is used. However, any other model may be used if the structure is an encoder/decoder structure where the first machine learning model is an encoder and the second machine learning model is a decoder. For example, U-net may be used.

In the feature map calculation unit 116, a subject image 60 and three reference images 65 are input to the encoder. If ResNet is used as the first machine learning model in the feature map calculation unit 116, feature maps obtained from each intermediate block can be calculated. More specifically, if the encoder shown in FIG. 6 is formed by five blocks each including a convolutional layer, first feature maps 61 having data sizes ½, ¼, ⅛, 1/16, and 1/32 of the data size of the subject image 60 are obtained by convolutional processing of the five blocks for the subject image 60. As for the reference images 65 as well, second feature maps 62 having data sizes ½, ¼, ⅛, 1/16, and 1/32 of the data size of the reference image 65 are obtained. Thus, using the outputs from the intermediate blocks, if the sizes of the feature maps of the intermediate blocks are different, a plurality of feature maps having different data sizes can be calculated.

The differential feature map calculation unit 117 calculates the difference between data sizes. In the example shown in FIG. 6, for each of the data sizes of ⅛, 1/16, and 1/32, the differences between the first feature maps 61 and the corresponding second feature maps 62 are calculated as differential feature maps 63. For example, the differential feature map calculation unit 117 calculates the Euclidean distance between the first feature maps 61 and the second feature maps 62 for each element, thereby calculating the differential feature maps 63.

In the likelihood map calculation unit 118, for each of the three types of data sizes, the differential feature maps 63 and the first feature maps 61 are coupled and input to the decoder that is the second machine learning model. The likelihood map calculation unit 118 outputs likelihood maps 66 concerning a plurality of types of anomalies using the output from the decoder that is the second machine learning model. For example, a P3 feature maps, a P4 feature maps, and a P5 feature maps output from the Feature Pyramid Network that is the decoder are coupled, and convolutional processing is performed. After that, a sigmoid function that is an activation function is applied, and the likelihood maps 66 concerning a plurality of types of anomalies are output. Here, the likelihood maps 66 are K maps, and K is the number of anomaly types. In the example shown in FIG. 6, the likelihood map 66 includes a score Sᵢⱼ indicating an anomaly likelihood for each region (i, j) in the subject image. Here, Sᵢⱼ is a continuous value from 0 to 1. If the value is large, it means that the probability of being an anomaly is high. After the scores Sᵢⱼ are calculated for all regions in the image using the second machine learning model, the likelihood calculation unit 119 calculates the maximum value of the scores Sᵢⱼ for all regions in the image as the score p for the entire image. For conversion from the likelihood map 66 to the score p for each entire image, Global Max Pooling is used. The score p is given by

$$p = {max}_{i , j} {s}_{ij} \qquad ( 3 )$$

Note that in FIG. 6, the score p is expressed as [p₁, p₂, . . . , p_{K}] using vector notation. As described above, here, K indicates the number of anomaly types. That is, K corresponds to the number of likelihood maps to be calculated. K=1 hold if only one anomaly type is to be detected. If there exist a plurality of types of anomalies, as many likelihood maps as the number of anomaly types are generated.

The loss value is calculated using BinaryCrossEntropy using the score p for the subject image 60 and the label y for the image, and the first machine learning model and the second machine learning model are trained such that the value is decreased.

By this training method, the first machine learning model and the second machine learning model can be trained such that the score sᵢⱼ for each region is low for a region including no anomaly and high for a region including an anomaly.

That is, the machine learning model is trained using data that teaches, to an image, the presence/absence of a specific anomaly to be detected in a predetermined unit such that a likelihood is output in a unit smaller than the predetermined unit, and the presence/absence of the taught anomaly to be detected and the maximum value of the output likelihood match.

According to the above-described first embodiment described, in weakly supervised learning that combines only a subject image and the presence/absence of an anomaly included in the subject image as a teaching label, a normal image similar to the subject image is input as a reference image to the first machine learning model, and the model is trained. In weak-supervised learning, since not which region of the image includes an anomaly but only the presence/absence of an anomaly is taught to the entire image, anomaly detection accuracy lowers due to the influence of the situation and the angle of view at the time of capturing the subject image. However, according to the training apparatus of the above-described first embodiment, the reference image is selected from normal images based on the similarity to the subject image, the differential feature map between the subject image and the reference image is calculated, and the likelihood map is calculated based on the feature map of the subject image and the differential feature map. It is therefore possible to train the model while reducing the influence of the image capturing state of the subject image and generate a trained model with improved anomaly detection accuracy.

### Second Embodiment

In the second embodiment, an image processing apparatus that executes inference processing using a trained model trained by a training apparatus 11 according to the first embodiment will be described.

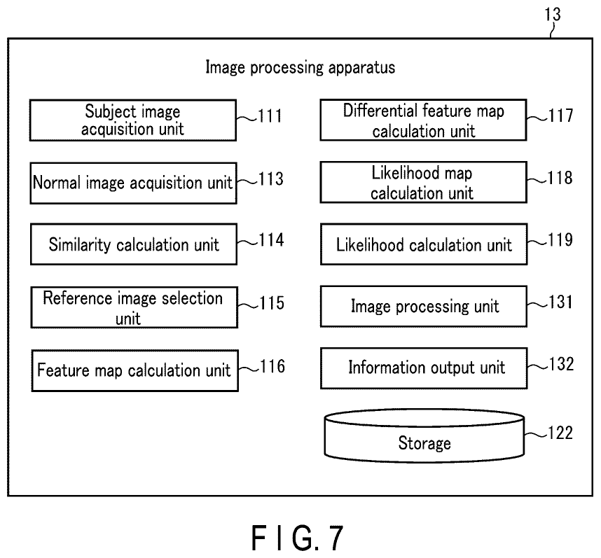

FIG. 7 is a block diagram of an image processing apparatus 13 according to the second embodiment.

The image processing apparatus 13 includes a subject image acquisition unit 111, a normal image acquisition unit 113, a similarity calculation unit 114, a reference image selection unit 115, a feature map calculation unit 116, a differential feature map calculation unit 117, a likelihood map calculation unit 118, a likelihood calculation unit 119, a storage 122, an image processing unit 131, and an information output unit 132.

The subject image acquisition unit 111, the normal image acquisition unit 113, the similarity calculation unit 114, the feature map calculation unit 116, the differential feature map calculation unit 117, the likelihood map calculation unit 118, and the likelihood calculation unit 119 perform the same processing as in the first embodiment, and a detailed description thereof will be omitted.

The reference image selection unit 115 selects at least one reference image sequentially from a normal image having a high similarity based on the similarity calculated by the similarity calculation unit 114.

The storage 122 stores the likelihood map of a subject image, a superimposed image obtained by superimposing the likelihood map on the subject image, and the like.

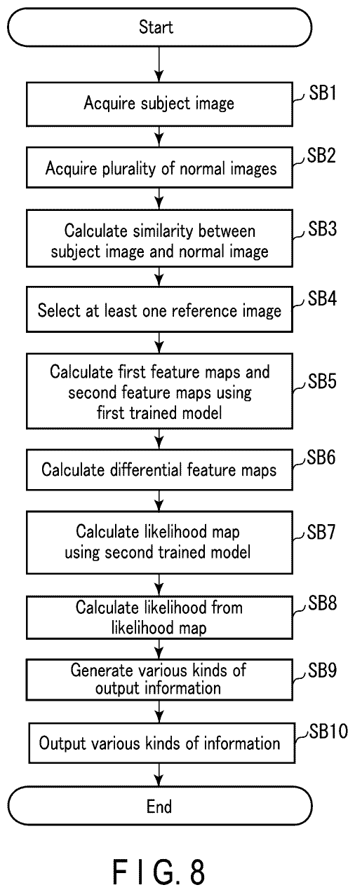

An example of the operation of the image processing apparatus 13 according to the second embodiment will be described next with reference to the flowchart of FIG. 8.

In step SB1, the subject image acquisition unit 111 acquires a subject image that is the target of inference processing.

In step SB2, the normal image acquisition unit 113 acquires a plurality of normal images.

In step SB3, the similarity calculation unit 114 calculates the similarity between the subject image and each normal image. The calculation method is the same as the processing of step SA3 according to the first embodiment.

In step SB4, the reference image selection unit 115 selects at least one reference image. Here, N top normal images having higher similarities may be acquired as reference images.

In step SB5, the feature map calculation unit 116 calculates the first feature maps of the subject image and the second feature maps of the reference image using a first trained model.

In step SB6, the differential feature map calculation unit 117 calculates the differences between the first feature maps and the second feature maps as differential feature maps.

In step SB7, the likelihood map calculation unit 118 calculates a likelihood map using a second trained model. In step SB8, the likelihood calculation unit 119 calculates a likelihood concerning the presence/absence of an anomaly in the subject image. Note that the processing of steps SB5 to SB8 is processing performed in a case where the first machine learning model and the second machine learning model in the training apparatus 11 according to the first embodiment are changed to the first trained model and the second trained model, and the same processing as in the first embodiment is performed.

In step SB9, the image processing unit 131 generates, using the subject image, the likelihood map, and the likelihood, various kinds of output information indicating whether an anomaly exists in the subject image. For example, the image processing unit 131 generates a superimposed image by superimposing the likelihood map on the subject image.

In step SB10, the information output unit 132 outputs the various kinds of output information generated in step SB9.

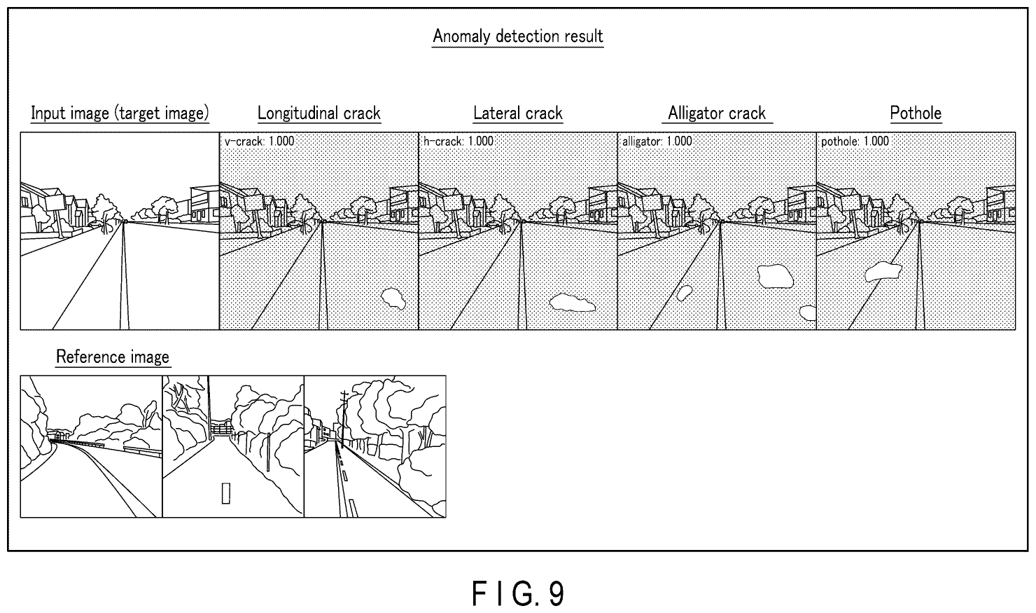

Next, FIG. 9 shows an example of the display screen of the image processing apparatus 13 according to the second embodiment.

FIG. 9 shows an example of an anomaly detection result display screen generated by the image processing apparatus 13 in a case where the subject image is an image associated with the surface of a road. If an anomaly of the road surface is detected by the image processing unit 131, the information output unit 132 outputs information associated with the anomaly. For example, the input image (subject image) to the image processing apparatus 13 and superimposed images corresponding to anomaly types are displayed in parallel. Reference images used for the processing of the subject image may also be displayed.

By viewing the display screen shown in FIG. 9, the user can easily grasp the presence/absence of an anomaly, and if an anomaly exists, the type of the anomaly and the anomaly position (a region in the subject image).

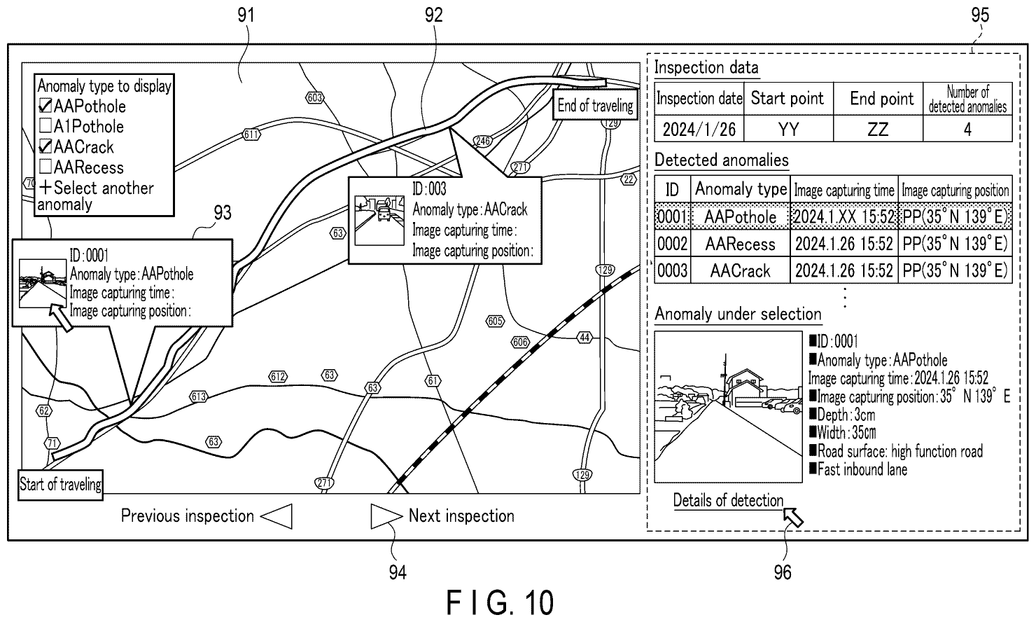

An example of application to an application concerning a detection result of the image processing apparatus 13 will be described next with reference to FIG. 10.

FIG. 10 shows an example of a display screen that displays at which point an image including a detected anomaly was captured on a traveling route in a case where the state of the road surface is captured by an imaging apparatus 20 and inspected while traveling with an automobile or the like. In FIG. 10, a map information display region 91 and an inspection result display region 95 are displayed.

In the map information display region 91, a map, a traveling route 92 on the map, the thumbnail image of a subject image in which an anomaly is detected, and attribute information thereof are displayed in a speech bubble 93. Also, as shown on the upper left side of the map information display region 91, a menu may be displayed such that types of anomaly images to be displayed on the map can be selected.

In the inspection result display region 95, inspection data, detected anomalies as the list of detected anomalies, and an anomaly under selection are shown. As the inspection data, for example, an inspection date, a start point, an end point, and the number of detected anomalies are displayed in association with each other. As the detected anomalies, an ID for uniquely identifying an image with an anomaly, an anomaly type, an image capturing time, and an image capturing position are displayed. As the anomaly under selection, a subject image, and details of attribute information concerning the anomaly included in the map information display region 91 are displayed.

In the example shown in FIG. 10, the speech bubble 93 of ID: 001 is selected, and the subject image and attribute information of ID: 001 are displayed as the image of the anomaly under selection. Note that the image may be switchable to a superimposed image if the subject image is clicked by a mouse cursor 96, or the user touches the image in a case of touch screen.

If “details of detection” among items of the anomaly under selection is selected, another window may be opened, and the display may be transitioned to a display screen to display detailed of detection such as enlarged display or a likelihood map. For example, the display may transition to the detection result display screen shown in FIG. 9.

Also, a selection button 94 may be provided to transition to the data of a different anomaly detection result on another route or another day.

Note that FIG. 10 shows an example of a case where the inspection target is a road surface, but the inspection target may be selected from a road surface, a guardrail, a sound insulation wall, and the like. For example, the user may manually classify guardrail images and set a subject image set of the inspection target. Alternatively, the inspection target may be determined and classified by applying a trained model for executing semantic segmentation processing to a subject image, superimposing the segmentation results of a road surface, a guardrail, or the like for each pixel on a likelihood map, and determining to which segmentation result a region estimated to have an anomaly corresponds.

According to the above-described second embodiment, the reference image selection unit selects a normal image similar to the subject image as a reference image, and inference is executed for the subject image using a trained model generated by the training apparatus according to the first embodiment. Highly accurate anomaly detection can thus be executed.

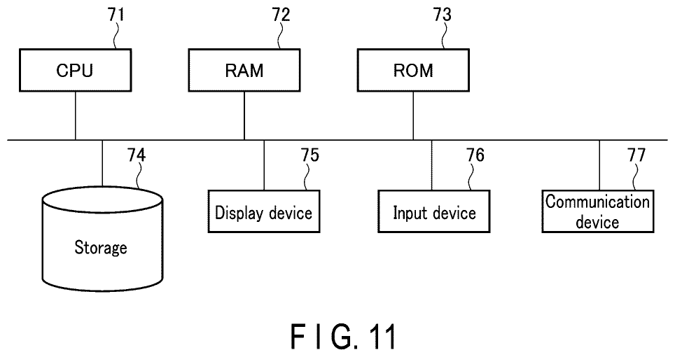

FIG. 11 is a block diagram showing an example of the hardware configuration of the information processing apparatus 10 including the training apparatus 11 and the image processing apparatus 13 according to each of the above-described embodiments.

The information processing apparatus 10 includes a CPU (Central Processing Unit) 71, a RAM (Random Access Memory) 72, a ROM (Read Only Memory) 73, a storage 74, a display device 75, an input device 76, and a communication device 77, and these are connected by a bus.

The CPU 71 is a processor that executes arithmetic processing or control processing in accordance with a program. The CPU 71 executes processing of each unit of the above-described information processing apparatus 10 in cooperation with a program stored in the ROM 73, the storage 74, or the like using a predetermined area of the RAM 72 as a work area. Note that each processing of the information processing apparatus 10 may be executed by one processor or may be distributedly executed by a plurality of processors.

The RAM 72 is a memory such as an SDRAM (Synchronous Dynamic Random Access Memory). The RAM 72 functions as the work area of the CPU 71. The ROM 73 is a memory that unrewritably stores programs and various kinds of information.

The storage 74 is a device that writes/reads data to/from a magnetic recording medium such as an HDD (Hard Disc Drive), a storage medium such as a flash memory using a semiconductor, a magnetically recordable storage medium such as an HDD, or an optically recordable storage medium. In accordance with the control from the CPU 71, the storage 74 writes/reads data to/from the storage medium.

The display device 75 is a display device such as an LCD (Liquid Crystal Display). The display device 75 displays various kinds of information based on a display signal from the CPU 71.

The input device 76 is an input device such as a mouse and a keyboard. The input device 76 accepts information operated and input from the user as an instruction signal and outputs the instruction signal to the CPU 71.

The communication device 77 communicates with an external device via a network in accordance with the control from the CPU 71.

Note that if the training apparatus 11 and the image processing apparatus 13 are not included as parts of the information processing apparatus 10 but constructed as independent apparatuses, each of the training apparatus 11 and the image processing apparatus 13 may have the hardware configuration shown in FIG. 11.

An instruction shown in the processing procedure explained in the above-described embodiments can be executed based on a program that is software. If a general-purpose computer system stores the program in advance and loads the program, the same effects as the effects by the control operation of the above-described information processing apparatus can be obtained. An instruction described in the above embodiments is recorded, as a program that can be executed by a computer, in a magnetic disk (a flexible disk, a hard disk, or the like), an optical disk (a CD-ROM, a CD-R, a CD-RW, a DVD-ROM, a DVD±R, a DVD±RW, a Blu-ray® Disc, or the like), a semiconductor memory, or a recording medium similar to these. The storage format can have any form if the recording medium can be read by a computer or an embedded system. If a computer loads the program from the recording medium and causes a CPU to execute an instruction described in the program based on the program, the same operation as the control of the information processing apparatus according to the above-described embodiment can be implemented. If the computer acquires or loads the program, it may be acquired or loaded via a network, as a matter of course.

Also, an OS (Operating System) that operates on a computer based on an instruction of a program installed from a recording medium to the computer or an embedded system, database management software, or MW (middleware) such as a network may execute some of processes for implementing the embodiment.

Furthermore, the recording medium according to this embodiment is not limited to a medium independent of the computer or embedded system, and a recording medium that downloads a program transmitted by a LAN or the Internet and stores or temporarily stores it is also included.

Also, the number of recording media is not limited to one, and a case where processing according to this embodiment is executed from a plurality of media is also included in the recording medium according to this embodiment, and the medium can have any configuration.

Note that the computer or embedded system according to this embodiment is configured to execute each processing according to this embodiment based on the program stored in the storage medium, and can have any configuration such as a single apparatus such as a personal computer or a microcomputer or a system formed by connecting a plurality of apparatuses via a network.

Also, the computer according to this embodiment is not limited to a personal computer and also includes an arithmetic processing apparatus or a microcomputer included in an information processing device, and generally indicates devices and apparatuses capable of implementing the functions according to this embodiment by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A training apparatus comprising processing circuitry configured to:
acquire a subject image and at least one normal image;
calculate a similarity between the subject image and the at least one normal image;
select at least one reference image from the at least one normal image based on the similarity;
calculate first feature maps of the subject image and second feature maps of the reference image using a first machine learning model;
calculate differential feature maps that are differences between the first feature maps and the second feature maps;
calculate a likelihood map based on the first feature maps and the differential feature maps using a second machine learning model;
calculate, based on the likelihood map and a teaching label of the subject image, a loss based on a likelihood; and
update the first machine learning model and the second machine learning model based on the loss.

2. The apparatus according to claim 1, wherein the processing circuitry is configured to:
acquire a plurality of normal images; and
probabilistically select the at least one reference image from the plurality of normal images based on the similarity.

3. The apparatus according to claim 1, wherein the processing circuitry is configured to:
acquire a plurality of normal images; and
randomly select at least one reference image from the plurality of normal images each having the similarity not less than a threshold.

4. The apparatus according to claim 1, wherein the processing circuitry is configured to:
select at least one reference image in accordance with a selection probability calculated from the similarity.

5. The apparatus according to claim 4, wherein the higher the similarity is, the larger the value of the selection probability is.

6. The apparatus according to claim 1, wherein the processing circuitry is configured to calculate the first feature maps having different output sizes from intermediate layers of the first machine learning model.

7. The apparatus according to claim 6, wherein the processing circuitry is configured to calculate the differential feature maps corresponding to the first feature maps.

8. The apparatus according to claim 1, wherein the processing circuitry is configured to:
acquire a plurality of normal images;
calculate each similarity between the subject image and the plurality of normal images;
select a plurality of reference images from the normal images based on the similarity; and
calculate a statistic of a feature map of each of the plurality of reference images as the second feature maps.

9. The apparatus according to claim 1, wherein the processing circuitry is configured to calculate the similarity based on a representation of the subject image and the at least one normal image obtained by using a neural network.

10. A training method comprising;
acquiring a subject image and at least one normal image;
calculating a similarity between the subject image and the at least one normal image;
selecting at least one reference image from the at least one normal image based on the similarity;
calculating first feature maps of the subject image and second feature maps of the reference image using a first machine learning model;
calculating differential feature maps that are differences between the first feature maps and the second feature maps;
calculating a likelihood map based on the first feature maps and the differential feature maps using a second machine learning model;
calculating, based on the likelihood map and a teaching label of the subject image, a loss based on a likelihood; and
updating the first machine learning model and the second machine learning model based on the loss.

11. An image processing apparatus comprising processing circuitry configured to:
acquire a subject image that is an inspection image and at least one normal image;
calculate each similarity between the subject image and the at least one normal image;
select at least one reference image from the at least one normal image based on the similarity;
calculate first feature maps of the subject image and second feature maps of the reference image using a first trained model trained by the training apparatus of claim 1;
calculate differential feature maps that are differences between the first feature maps and the second feature maps;
calculate a likelihood map based on the first feature maps and the differential feature maps using a second trained model trained by the training apparatus of claim 1; and
generate output information relating to the subject image and the likelihood map.

12. The apparatus according to claim 11, wherein the processing circuitry is configured to select a normal image having the highest similarity as a reference image.

13. The apparatus according to claim 11, wherein
the processing circuitry is configured to acquire a plurality of normal images, and
select the plurality of normal images as the reference images in descending order of similarity.
